(19) United States
(12) Patent Application Publication
(10) Pub. No.: US 2019/0152011 A1
(43) Pub. Date: May 23, 2019

(54) PREDICTIVE CUTTING TOOL FAILURE DETERMINATION

(71) Applicant: General Electric Company, Schenectady, NY (US)

(72) Inventors: Prudvi Raj Kummari, Bangalore (IN); Vikrant Damle, Bangalore (IN); Abhishek Narain, Bangalore (IN)

(21) Appl. No.: 15/819,393

(22) Filed: Nov. 21, 2017

(51) Int. Cl. B23Q 17/09; G06N 99/00; G06N 5/04

(52) U.S. Cl. CPC B23Q 17/0995; B23Q 17/005; G06N 5/04; G06N 99/005

(57) ABSTRACT

The example embodiments are directed to a system and method for determining the health of a cutting tool used in milling operations or the like. In one example, the method may include receiving operating characteristics of a cutting machine which are captured during an iteration of a cutting operation, generating a signature pattern associated with the cutting machine based on the operating characteristics, the signature pattern representing a unique pattern of the operating characteristics of the cutting machine during the cutting operation, determining health information of a cutting tool of the cutting machine based on the signature pattern and a benchmark signature pattern, and outputting the determined health information of the cutting tool for display on a display device. Accordingly, a cutting tool can be replaced at the optimum time thereby improving productivity and conserving cost.

### BACKGROUND

Low-level software and hardware-based controllers have long been used to drive machine and equipment assets such as machines and equipment located at a manufacturing plant. However, due to a recent rise of inexpensive cloud computing, increasing sensor capabilities, decreasing sensor costs, as well as the proliferation of mobile technologies, new opportunities for creating novel industrial and healthcare based assets as well as novel enhancements to assets are possible. As a consequence, there are new opportunities to enhance the business value of some assets through the use of novel industrial-focused hardware and software.

A significant portion of operational overhead at a manufacturing plant is a result of unreliable assessment of tool health. One example is a cutting tool (e.g., milling cutter) that is typically used in milling machines to perform milling operations that including removing, drilling, turning, and cutting material. Across manufacturing plants, cutting tool replacement processes are performed manually. Typically, an operator makes a guess at when a cutting tool needs to be replaced based on prior experience, intuition, experiments, or the like, creating a human bias factor. In some cases, the subjective determination can be too conservative or too aggressive. A conservative estimate results in changing the cutting tool too quickly thus incurring higher costs. Meanwhile, an aggressive estimate may push the cutting tool beyond its life resulting in deterioration of the work product and eventually downtime as a result of tool failure.

Some recent systems have begun using cutting parameters to predict tool failure. In these systems, hand labeled data is often used for training the system to make predictions. This manual labeling process is heuristic driven thus adding significant human bias. Also, a cutting tool can fail randomly and quite rapidly due to various unforeseen events such as mechanical breakage or quick dulling. These types of random failures are not addressed in the conventional manufacturing plant scenario. Accordingly, what is needed is a system that addresses and identifies different causes of failure, and informs when a cutting tool should be replaced thereby reducing costs, defects, re-work, scrappage, downtime, etc. and improving productivity and profitability.

### SUMMARY

The example embodiments improve upon the prior art by providing a real-time machine learning software program and system which determines/predicts when a cutting tool failure is going to occur by learning latent signature patterns of various sensor signals associated with the cutting tool and the cutting machine such as cutting force, acoustic emissions (sound), vibrations, current (AC/DC), and the like. The system can determine how much life a cutting tool (also referred to as a machine cutter) has remaining based on the latent signatures patterns included in the sensor data and predict tool failure in advance thereby allowing appropriate steps to be taken to reduce milling downtime, workpiece scrappage and re-work thereby improving productivity and profitability. The system described herein delivers a unique way of helping an end user monitor the health of a cutting tool and recommends when to replace the tool.

The system may leverage signal processing, feature extraction, pattern recognition, anomaly detection, and clustering as art of the machine learning. The system may combine data from heterogeneous sensor sources and detect a random set of events/patterns. Accordingly, the system surpasses the predictable accuracy of insights delivered by subject matter experts. The model is built on the fact that when a cutting tool has reached the end of its life, load variations increase significantly which eventually leads to failure of the tool. In some embodiments, the system and the software may be incorporated within a cloud computing environment of an Industrial Internet of Things (IIoT).

According to an aspect of an example embodiment, a method includes one or more of receiving operating characteristics of a cutting machine which are captured during an iteration of a cutting operation, generating a signature pattern associated with the cutting machine based on the operating characteristics, the signature pattern representing a unique pattern of the operating characteristics of the cutting machine during the cutting operation, determining health information of a cutting tool of the cutting machine based on the signature pattern and a benchmark signature pattern, and outputting the determined health information of the cutting tool for display on a display device.

According to an aspect of another example embodiment, a computing system includes one or more of a receiver configured to receive operating characteristics of a cutting machine which are captured during an iteration of a cutting operation, a processor configured to generate a signature pattern associated with the cutting machine based on the operating characteristics, the signature pattern representing a unique pattern of the operating characteristics of the cutting machine during the cutting operation, and determine health information of a cutting tool of the cutting machine based on the signature pattern and a benchmark signature pattern, and an output configured to output the determined health information of the cutting tool for display on a display device.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cutting machine including a cutting tool for performing cutting operations in accordance with an example embodiment.

FIG. 2 is a diagram illustrating a system for determining health of a cutting tool in accordance with an example embodiment.

FIG. 3 is a diagram illustrating a graph displaying signature patterns of an operating characteristic of a cutting machine in accordance with an example embodiment.

FIG. 4 is a diagram illustrating a graph displaying an anomaly signature pattern in accordance with an example embodiment.

FIG. 5 is a diagram illustrating a clustering process for clustering signature patterns in accordance with an example embodiment.

FIG. 6 is a diagram illustrating a dashboard for providing tool health information in accordance with an example embodiment.

FIG. 7 is a diagram illustrating a method for determining health information of a cutting tool in accordance with an example embodiment.

FIG. 8 is a diagram illustrating a computing system for determining health information of a cutting tool in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a system and method that perform machine learning based on historic runs of a cutting machine to generate a machine learning model. The machine learning module can be used by the system to monitor, in real-time, a cutting tool during operation to determine health information of the cutting tool. For example, the system can predict when tool failure will occur and how far into the future the tool failure will occur. Furthermore, the system can output a notification to a plant operator with insight into the life and health of the cutting tool as well as notifications when it is or when it will be time to replace the cutting tool. The system can generate a latent signature of operating characteristics of the cutting machine which can be used to detect an amount of life left with a cutting tool of the cutting machine. The latent signature can be generated based on sensor signals acquired from the cutting machine during cutting operations. Here, the acquired sensor information may identify cutting information such as cutting force, acoustic emissions (sound), vibrations, power (AC/DC), and the like, which are sensed from different components of the cutting machine such as a spindle, a table, and the like. Each sensor signal may have its own respective latent signature pattern.

According to various aspects, the system can generate a benchmark signal for the operating characteristics based on historical latent signature patterns of the operating characteristics (or that particular sensor capturing the operating characteristics). When new operational data of the cutting machine is received, the system can generate a new latent signature pattern from various operating characteristics such as load, vibrations, sound, power consumption, etc., and determine a current health of a cutting tool of the cutting machine based on the previously generated benchmark signature pattern. For example, the system can compare the new latent signature pattern with the benchmark signature pattern, and cluster the results into one of a plurality of clusters based on the comparison. Here, each cluster may represent a different health status of the cutting tool such as end of life, near end of life, healthy, etc. That is, by assigning the new signature pattern to a cluster, the machine learning model can determine a current health of the cutting tool. Predicting tool failure in advance allows appropriate steps to be taken to reduce milling downtime, workpiece scrappage and re-work thereby improving productivity and profitability at the mill or plant. The system described herein delivers a unique way of helping the end user in monitoring health of a cutting tool and further recommends when to replace the tool based on a latent signature of the tool.

The system may be implemented within an Industrial Internet of Things (IIoT). As an example, the IIoT may connect assets, such as turbines, jet engines, locomotives, healthcare devices, mining equipment, oil and gas refineries, milling machines, and the like, to the Internet or cloud, or to each other in some meaningful way such as through one or more networks. The cutting tool software described herein can be implemented within a “cloud” or remote or distributed computing resource. The cloud can be used to receive, relay, transmit, store, analyze, or otherwise process information for or about assets and manufacturing sites which include or are otherwise associated with cutting and milling operations. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, security, or some other function.

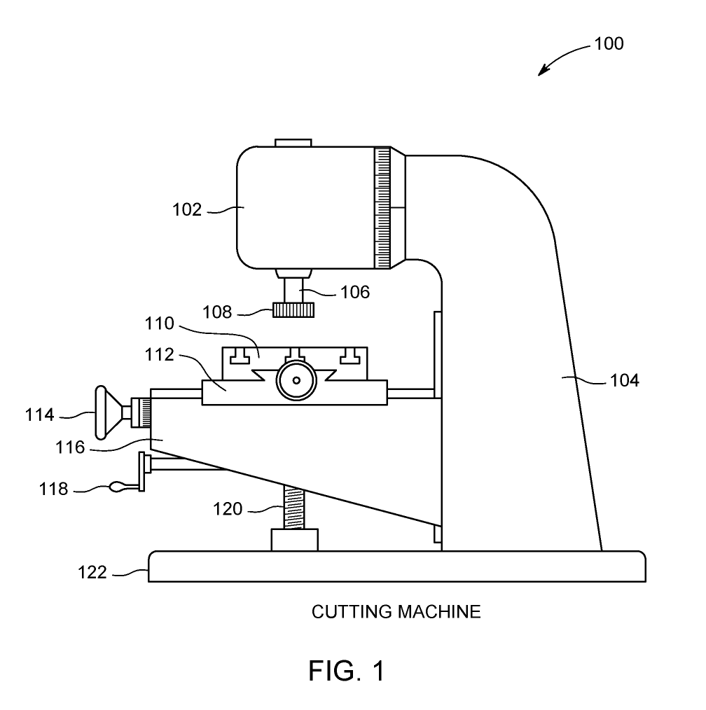

FIG. 1 illustrates a cutting machine 100 that may be used for milling operations in accordance with an example embodiment. In this example, the cutting machine 100 is a vertical cutting machine, however, the embodiments are not limited thereto. As another example, the cutting machine may be a horizontal cutting machine, or the like. Also, the cutting machine may be a knee-type, ram-type, manufacturing-type, bed-type, planar-type, and the like. The type of cutting machine is not limited. Referring to FIG. 1, the cutting machine 100 includes a cutter 108 (i.e., cutting tool) that is configured to contact a workpiece to remove material, cut material, move material, rotate material, and the like, from the workpiece. The cutter 108 may be rotated and angled to achieve a desired design within the workpiece. The cutting tool 108 may be of different types which can include different shapes, sizes, materials, and the like. Cutting tools are usually made of materials that are harder than the workpiece they are cutting. Examples of cutting tool types include an end mill, a ball nose cutter, a square cutter, a T-slot cutter, a gear cutter, a slab mill, a side-and-face cutter, a face mill, a hollow mill, a shell mill, a fly cutter, and the like. The cutting tool 108 may have teeth, flutes, roughing, finishing, and the like. The cutting tool may also be angled or it may not be angled.

The cutting machine also includes a table 110 on which a workpiece may be fed or placed and which can move in both X and Y directions with respect to the cutter 108 by saddle 112 can be controlled by saddle knob 114. The saddle 112 rests on knee 116 which is capable of being moved up and down with respect to base 122 by turning elevating knob 118 which causes elevating screw 120 to rotate the knee 116 up and down. The knee is also supported by column 104 which includes an attachment mechanism that enables the knee 116 to move up and down while remaining in contact with column 104. The top portion of the column 104 is vertical milling head 102 which has integrated therein spindle 106 which holds the cutter 108 and which causes the cutter 108 to rotate. The spindle 106 is a rotating axis of the cutting machine 100 and may also be referred to as a shaft. Some cutting machines may include multiple spindles 106 and multiple cutters 108, however for convenience only one is shown.

In operation, a workpiece may be held by table 110 and contacted from above by cutter 108 which is electrically rotated by the spindle 106 to thereby create cuts within a workpiece. Although not shown in FIG. 1, the cutting machine 100 also includes a power source (electrical box, etc.) which may be plugged into one or more outlets or generators and which powers the components of the cutting machine 100. The cutting machine 100 may also include one or more switches, control levers, buttons, and the like, for controlling the speed at which the spindle 106 rotates, movement of the table 110 and/or the saddle 112, and the like. The cutting machine 100 may also include an oil tank for lubricating various components of the cutting machine 100 such as the joint between the table 110 and the saddle 112, the spindle 106, and the like.

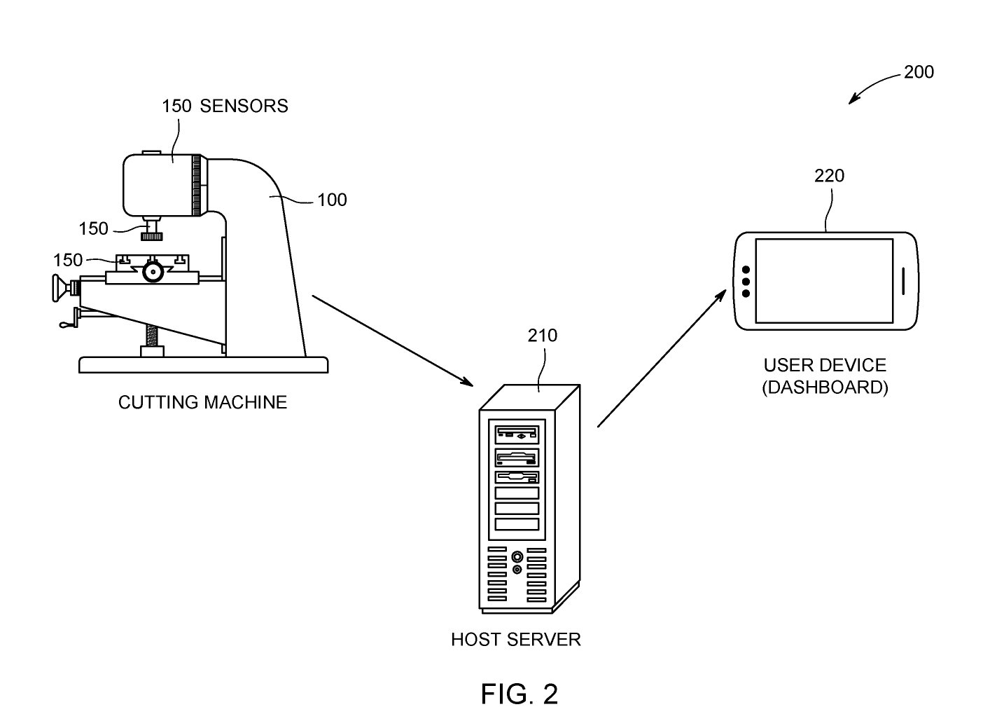

FIG. 2 illustrates a system 200 for determining health of a cutting tool in accordance with an example embodiment. Referring to FIG. 2, the system 200 includes a cutting machine 100 (e.g., the cutting machine shown in FIG. 1), a host server 210 that hosts the health determination software program described herein, and a user device 220 which connects to the host server 210 and receives information related to the performance of the cutting machine 100 including health information, notifications, warnings, and the like. The cutting machine 100 may be connected to the host server 210 via a local network such as in an on-premises environment. As another example, the cutting machine 110 and the host server 210 may be connected through a network such as the Internet, a private network, and the like. In this later example, the host server 210 may be a web server, cloud platform, and the like, which is part of a larger Industrial Internet of Things (IIoT). The user device 220 and the host server 210 may also connect via a network.

In this example, the host server 210 may be a cloud computing system. In this example, an asset management platform (AMP) can reside in cloud computing system, in a local or sandboxed environment, or can be distributed across multiple locations or devices and can be used to interact with other assets (not shown). The AMP can be configured to perform functions such as data acquisition, data analysis, data exchange, and the like, with local or remote assets associated with a production plant including the cutting machine, or with other task-specific processing devices. For example, the AMP may be connected to an asset community (e.g., turbines, healthcare, power, industrial, manufacturing, mining, oil and gas, etc.) which may be communicatively coupled to the cloud computing system.

Furthermore, the cloud computing system may host the cutting tool health determination software program described herein. That is, the software may be deployed within the cloud computing system and accessible to users such as the user device 220, and other user devices. The software residing on the host server 210 is capable of receiving data from or about the cutting machine 100 from one or more sensors 150 attached to or associated with the cutting machine 100. Furthermore, the sensor data may be processed to determine a health of a cutting tool of the cutting machine 100. The health of the cutting tool may be output to the user device 220 for display and further action. Also, the sensors 150 may be positioned in and around the cutting machine 100 (not necessarily in contact with the cutting machine 100). The sensors may sense time-series data and transmit the data back to the host server 210.

Types of sensor data include cutting force (load) at the spindle, at the table, and the like. The sensor data may include acoustic emissions at the spindle, at the table, and the like, the sensor data may include vibrations at the spindle, at the table, and the like. As another example, the sensor data may detect power (AC/DC) consumed by the cutting machine 100 while it performs cutting operations. The sensor data may be collected in periods or intervals of time. Each interval (or iteration) may include a single cutting operation, multiple cutting operations, a partial cutting operation, and the like. Sensor data such as cutting force, acoustic emissions and vibrations can be captured at multiple points on the cutting machine (e.g., spindle, table, head, etc.). Power sensor data may be the same at all points and may be captured once but there are two types of power AC and DC. The sensors information may be used to determine wear to the cutting tool of the cutting machine. In addition, there are other parameters that may be considered by the software program which can indirectly influence a signature pattern of the operating characteristics. These other parameters include cutting parameters such as depth of cut and cutting speed, type of material on which the cutting operation is performed (e.g., iron, steel, wood, etc.), cutting tool properties such as tool material (e.g., high speed steel, centered carbide, etc.) and tool geometry (e.g., number of teeth, diameter, shape, etc.).

The user device 220 (e.g., smart phone, workstation, tablet, appliance, kiosk, and the like) may connect to the host server 210 via a network such as the Internet, a private network, a combination thereof, and the like. The user device 220 may register for or otherwise receive authorization to access one or more applications hosted by the host server 210 including the cutting tool health software. In operation, the user device 220 may display a dashboard that simultaneously provides machine health information for multiple different cutting machines located at a production plant. The user device 220 can be used to monitor or control one or more machines or equipment at the production plant, for example, via the dashboard.

According to various example embodiments, the system 200 includes a sensor monitoring system (i.e., sensors 150) to capture data from the milling machine 100 in real-time. The system 200 also includes a machine Learning model (i.e., software executing on host server 210) which predicts tool failure in advance and a dashboard (i.e., output on the user device 220) which helps the end user make data driven decisions by monitoring tool health and alerting the user when a tool is about to fail. To predict tool end of life accurately, signals may be acquired from during a milling process (e.g., a cutting operation). Multiple sensor monitoring system can be setup with only one single sensor to capture all relevant data or multiple different sensors to capture data from different components of milling machine. Though either systems will suffice, the latter can be used to combine several information sources related to different variables thereby developing a more accurate tool end of life predictor. Sensor data along with cutting parameters and tool & material properties may be stored by the host server 210 for every run.

Model building may be performed to build a training set capable of predicting an end of life for a cutting tool based on previous cutting operations performed by the cutting tool. Model building may include a pre-processing step in which raw historical data is first transformed and cleaned to get event records from asynchronous tags. Data is then treated to deal with outliers and missing values to ensure high prediction accuracies. The model building process may also include a signal processing step in which sensors installed on the cutting machine provide raw signals such as cutting force, acoustic emissions etc. But often raw signals are composed of noise. Signal processing techniques are first applied to filter noise from the raw signals. Next the model building may include feature extraction in which processed sensor data is transformed into more informative characteristics by extracting key features that will help in training the machine learning model. Examples of key features include area under the curve, spectral entropy, load values above mean, first order correlations, first order covariance, and the like.

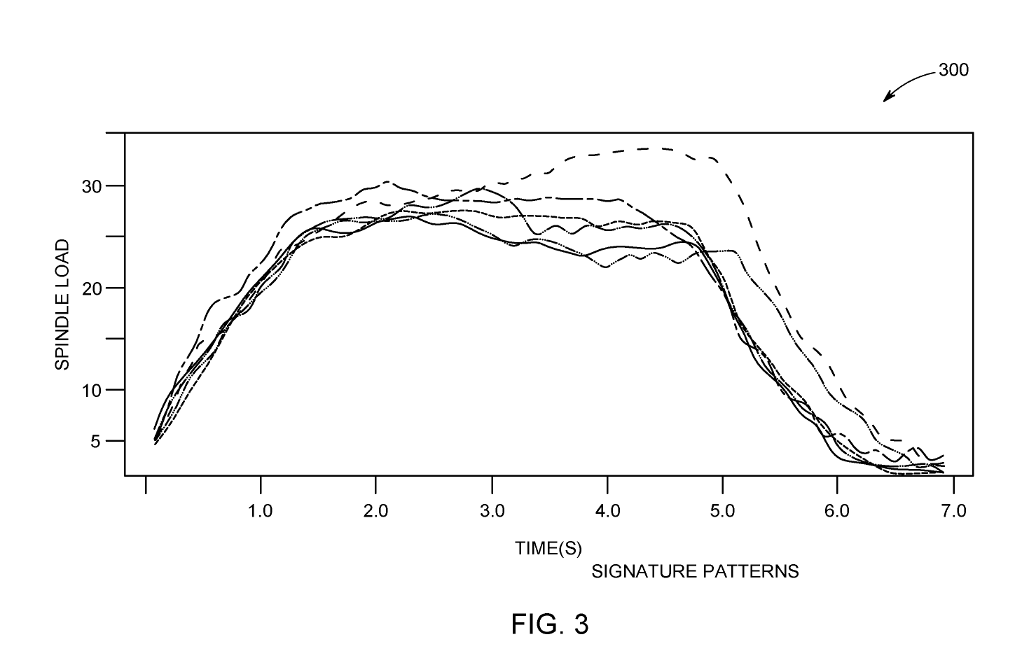

FIG. 3 illustrates a graph 300 displaying signature patterns of an operating characteristic of a cutting machine in accordance with an example embodiment. Referring to FIG. 3, the signature patterns represent an operating characteristic (i.e., cutting force) of a component (spindle) of the cutting machine over time. Here, each signature may represent a single cutting operation, but the embodiments are not limited thereto. The cutting force may be measured by a sensor installed on or otherwise associated with the cutting machine. Sensors installed on the machine may provide raw signals such as triaxial cutting force (Fₓ, F_{y} and F_{z}—force in all directions) in this example. But often raw signals are composed of a structured component that represent inherent properties of the variable under study and a random component that represent noise. Signal processing techniques such as Kalman filter, wavelet transformation may be first applied to filter noise from the raw signals. Processed sensor data is transformed into more informative characteristics or footprints of the variables by extracting key features such as those listed above that will help in generating the signatures. The machine learning model understands and generates the signature of a sensor signal using the features extracted. The sensor signature may be calculated for every run and used further in model building. As more runs are completed by the cutting machine the model continues to acquire sensor data for each run and build the model for predicting the life remaining for the cutting tool.

In the example of FIG. 3, the signature patterns are generated based on force of a spindle over time. However, the signature patterns may be generated based on force of a table over time or another component of the cutting machine. Also, the signature patterns may be generated for other parameters instead of cutting force such as acoustic emissions produced by the spindle, table, etc., vibrations produced by the spindle, table, etc., power consumption by the cutting machine, and the like. In some cases, signature patterns of multiple different parameters may be analyzed to generate a more accurate end of life prediction for the cutting tool.

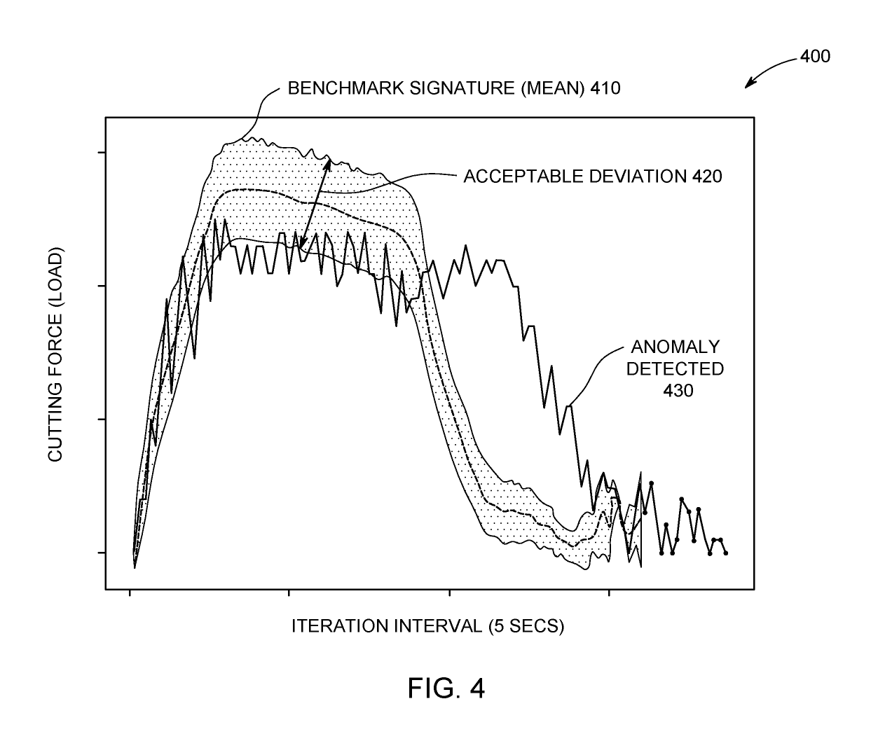

FIG. 4 illustrates a graph 400 displaying an anomaly signature pattern 430 in accordance with an example embodiment. Referring to FIG. 4, the anomaly signature pattern 430 corresponds to a newly received signature pattern of an operating characteristic (cutting force) of a component (spindle) of the cutting machine. The machine learning system software compares the signature pattern 430 to a benchmark signature pattern 410 which has already been generated based on historical operations of the cutting tool. In this case, an anomaly is detected when a signature pattern (such as signature pattern 430) falls outside of an acceptable deviation 420 from the benchmark signature pattern 410.

Every sensor signal has a unique signature. A new or current signature pattern of operating data captured by a sensor may be compared with the benchmark 420 of operating data captured by the sensor to detect anomalies. If the current signature deviates significantly from the benchmark curve, it is likely an indication that an anomaly is being detected and the cutting tool is nearing or has reached the end of its life. In a situation in which the model comes across a new pattern that was not seen in training data, Bayesian Change point detection technique may be used to learn the new pattern and detect any anomalies. This complements the anomaly detection techniques well. For example, the Bayesian change point detection is able to find any new or unseen anomalous patterns so that no anomalous pattern goes unnoticed by the model.

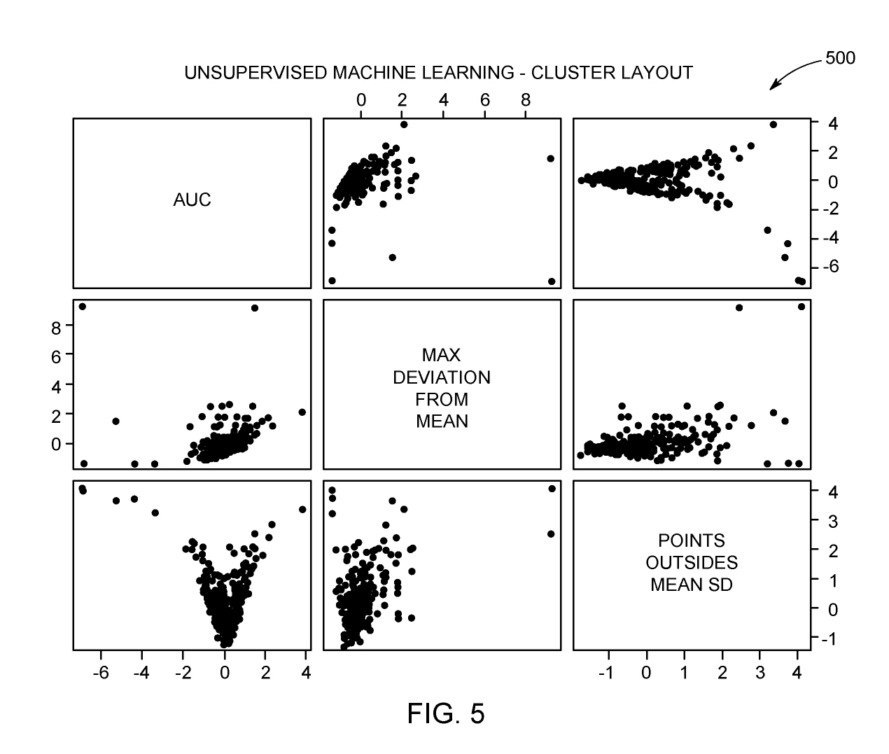

FIG. 5 illustrates a clustering process 500 for clustering signature patterns in accordance with an example embodiment. Referring to FIG. 5, clustering, an unsupervised technique, is used to organize observations into groups based on their similarity. For example, using a K-means clustering algorithm, all the instances of the signature patterns of the cutting machine may be organized one of a plurality of groups (i.e., clusters) based on characteristic signatures and computed summary statistics such as relative average deviation, relative average of the AUC, relative average points outside mean standard deviation, etc. These summary statistics are compared across the clusters to identify the cluster with anomalies based on the learnings from exploratory data analysis and anomaly detection from previous steps. In this non-limiting example, four (4) clusters are observed across the three features mentioned above. Clusters are then labeled based on level of anomalies exhibited. This labeled data is then used for training the machine learning model. Currently, hand labeled data is used to train the machine learning model and it means doing the same mistake that we are trying to avoid in the first place, to avoid human bias in the process.

For example, the clusters identified may include an end of life cluster which includes signature patterns that exhibit significant anomalies, a nearing end of life cluster that includes signature patterns that exhibit some anomalies, a health cluster which includes signature patterns that exhibit no anomalies, and a slight degradation cluster in which the signature patterns exhibit small but almost insignificant anomalies. In some embodiments, subject matter experts (SMEs) can further improve the cluster labeling by giving feedback. The machine learning model may be trained on the labeled clustered data. An ensemble model combining several machine learning techniques such as XGBoost, Random Forest, SVM may be used to get additional accuracy. This trained model may be used to predict tool failures in advance.

The machine learning model may be trained on the labeled data to understand which factors play a role in detecting anomalies and thereby help predict whether a tool has reached its end of life. Data may be divided in to train (e.g., 70%, etc.) and test (e.g., 30%, etc.) sets which are used to train and validate the model respectively. The model achieved 87% accuracy on training data and 82% accuracy on unseen data. An ensemble model combining several machine learning classification techniques mentioned below can be used to get consistently high accuracies. For example, failure prediction accuracies may be achieved by combining one or more of random forests, support vector machine, extreme gradient boosting, bagging, logistic regression, and the like.

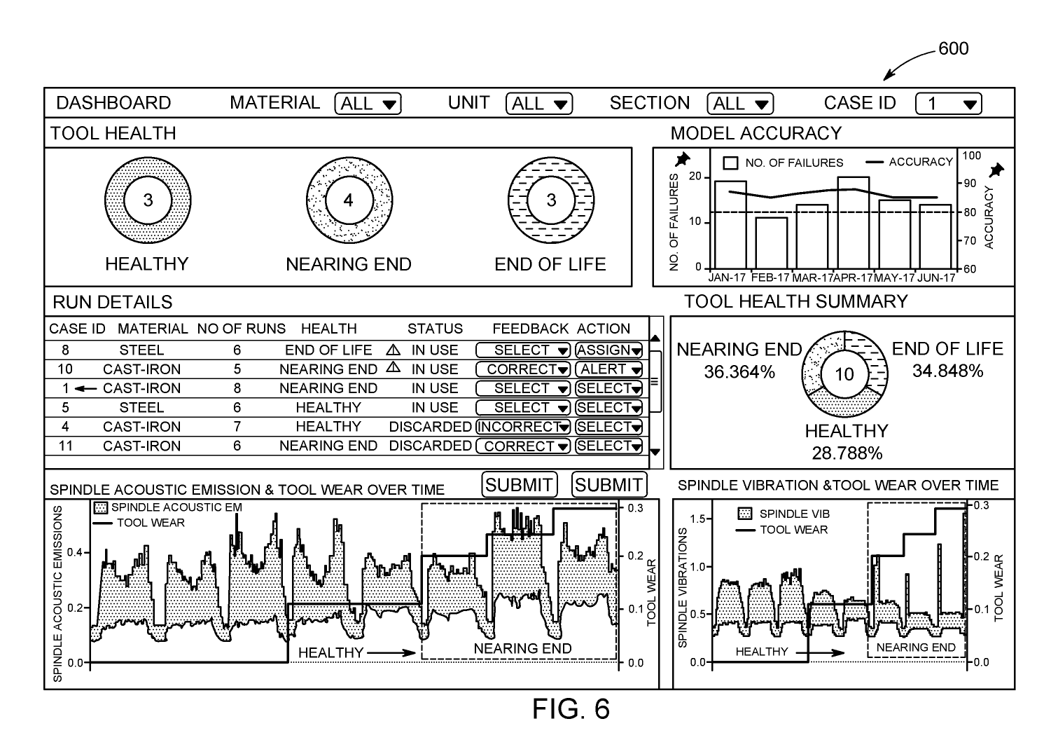

FIG. 6 illustrates a dashboard 600 for providing tool health information in accordance with an example embodiment. The dashboard may be output to a workstation or other user device such as user device 220 shown in FIG. 2. Referring to FIG. 6, real time sensor data is fed to the trained model. As a result, the model will send alerts to the user through the dashboard 600 in case of any significant anomalies and provide recommendations on any tools that need to be changed (if any). Accordingly, a user can monitor health of all the tools online. For example, the model may have information of whether a tool has failed and when a tool has failed. (e.g., Tool A has failed at the age of 4 weeks and 50 runs). Combining these variables, a survival object is created and is in turn used in survival regression analysis to predict the time when a tool is going to break. Remaining tool life may be calculated from subtracting current tool life from the predicted tool life. Accordingly, cutting tools with the lowest remaining life are shown in the dashboard 600 as they are the most pressing issues.

Once the model is trained on historical data, real time data after every run is fed to the model. Model will send alerts to the user through the dashboard 600 in case of any significant anomalies and give out recommendations on list of tools that need to be changed (if any) and a time period during which those tools should be replaced. The user can monitor the health of all the tools via the dashboard 600. Accordingly, the user can replace tools which have reached end of life at the most optimum time. The landing page of the dashboard 600 may provide a quick summary of number of tools that are 1. healthy, 2. nearing end of life and 3. reached end of life. The dashboard 600 may also provide a tool wise health report while prioritizing tools that have reached end of life. It also shows key graphs for a given tool which gives more details about the tool's health. The user can also view more graphs for a specified part if needed.

From the dashboard 600 the user can also take actions. For example, the user can take an action on a tool that has reached end of life by discarding the tool. In this example, the user can assign it to the concerned parties or send an alert via mail or a message. As another example, the user can validate recommendations (Healthy/End of Life) given by the model and give feedback to the model through the same dashboard 600. In this example, the model will learn from the feedback given by the SME and will avoid doing such mistakes again. SME's knowledge is incorporated in to this model so that his knowledge is not lost when he leaves the organization. The dashboard may also track the accuracy of the model on a periodic basis (e.g., monthly). It will send an alert when the model accuracy drop beyond a specified threshold indicating that model should be retained on the new data. This step ensures that the model is up to date with the latest data and trends.

Some of the advantages of this system include the ability to process high-frequency sensor signals, and predict cutting tool end of life purely based on sensor data (no assumptions or theoretical thresholds) and send real-time recommendations on tool replacement to a user. It can also quickly scale up with data as the model is based on advanced machine learning techniques. The system can assign labels to all the tools (healthy, nearing end, end of life, etc.) automatically using advanced clustering and anomaly detection methods. This labeled data is then used for training the machine learning model. The machine learning model can only be as good as the training data. Current day, labeling of unstructured data is done manually which is prone to the same errors that we are trying to prevent in first place. The manual labelling process is completely heuristic driven since it is based on formulas, prior experience, intuition or experiments and therefore adds a huge dimension of human bias. The proposed system labels historical data and gives out failure predictions entirely based on sensor data. There are no assumptions or theoretical thresholds involved. This step completely removes the human bias and the errors that originate from it.

The system may also Incorporates SMEs knowledge in to the software analysis so that SME's knowledge is not lost when the SME leaves the organization. Two steps at which SME can give feedback or impart his knowledge are a) verifying the labeling and clustering of the tools, and b) verifying the end predictions of the tool. Our standalone model achieved 87% accuracy. With SME's feedback this accuracy can be further improved. This system is near perfect after SME's knowledge is incorporated into the tool.

The system can also perform real-time tool health monitoring, failure prediction and sending real time alerts. The system enables monitoring tool life by estimating the remaining life of a tool based on survival analysis and sending out real time recommendation to replace the tool whenever significant anomalies are detected. In this process, anomalies may be detected from real-time high frequency sensor signals by learning the latent signatures/pattern leveraging several advanced anomaly detection methods. When the model comes across a new pattern that was not seen in training data, Bayesian change point detection technique may be able to learn the pattern and try to detect any anomalies. Furthermore, the system can be applied in any manufacturing plant across industries which involves milling process. This can be used for any type of milling process, machine, material etc. given enough sensors are installed.

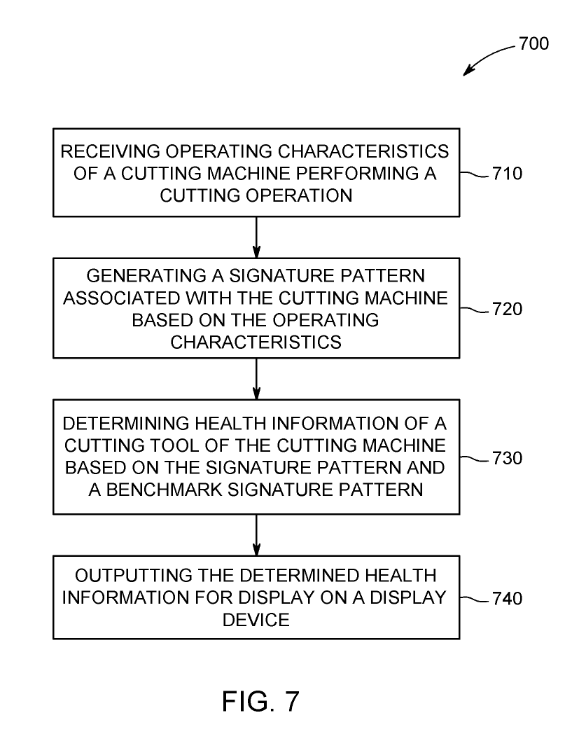

FIG. 7 illustrates a method 700 for determining health information of a cutting tool in accordance with an example embodiment. For example, the method 700 may be executed by a computing device or in a distributed manner across multiple computing devices. The computing devices may include a cloud platform, a server (e.g., remote, on-premises, etc.), a user device such as a terminal or a workstation, and the like. Referring to FIG. 7, in 710 the method includes receiving operating characteristics of a cutting machine which are captured during an iteration of a cutting operation. The iteration may include a single cutting operation for a workpiece, multiple workpieces, a partial workpiece, and the like. According to various embodiments, the operating characteristics may include operating characteristics measured or sensed by one or more sensors and obtained from components of the cutting machine. For example, the operating characteristics may include a load applied by a cutting force, a vibration, an acoustic emission, power consumption of the cutting machine, and the like. Here, the operating characteristics may be sensed from components related to a cutting tool such as a spindle, a table, and the like.

In 720, the method includes generating a signature pattern associated with the cutting machine based on the operating characteristics. According to various embodiments, the signature pattern represents a unique pattern of the operating characteristics of the cutting machine sensed by a sensor during the cutting operation. For example, the operating characteristics may be one or more of a cutting force, a vibration, an acoustic emission, a power consumption, and the like, sensed from one or more components of the cutting machine. The signature pattern may be a graph of the sensed characteristic over time creating a pattern such as shown in the examples of FIGS. 3 and 4. The sensed characteristic may change or fluctuate over time thereby generating a unique signature pattern of characteristic being sensed by the sensor. This characteristic may be unique to a respective characteristic of a respective cutting machine.

In 730, the method includes determining health information of a cutting tool of the cutting machine based on the signature pattern and a benchmark signature pattern, and in 740, the method includes outputting the determined health information of the cutting tool for display on a display device. For example, the determined health information of the cutting tool may include a determined amount of life remaining before the cutting tool will fail, a level of wear of the cutting tool, an indication that the cutting tool needs replacement in a certain amount of time (e.g., X days from now, etc.), and the like. Accordingly, operating characteristics of components of the cutting machine may be used to detect wear of a cutting tool. In some embodiments, the method may further include generating the benchmark signature pattern based on previous iterations of the cutting operation, for example, by averaging or capturing the mean of signature patterns generated by the operating characteristics of the cutting machine during the previous iterations. In some embodiments, the operating characteristics are received from a plurality of sensors associated with the cutting machine. In this example, the generating may include generating a signature pattern for each sensor from among the plurality of sensors, and determining the health information of the cutting tool based on a combination of the signature patterns of all of the plurality of sensors.

For example, the health information of the cutting tool may be determined based on a signature pattern of a cutting force compared to a signature pattern of the cutting force. As another example, the health information of the cutting tool may be determined based on a signature pattern of an acoustic emission signature pattern compared to a benchmark acoustic emission signature pattern. As another example, the health information of the cutting tool may be determined based on a signature pattern of a vibration signal of the cutting machine compared to a benchmark vibration signal. As another example, the health information of the cutting tool may be determined based on a signature pattern of power consumption by the cutting machine (or a component thereof) compared with a benchmark signature patter for power consumption.

Furthermore, the determining the health information may include determining that the cutting tool should be replaced, or otherwise predict a date or time in the future when the cutting tool should be replaced based on the signature pattern and the benchmark signature pattern and outputting a notification to the display device indicating that the cutting tool should be replaced. In some embodiments, the determining the health information may include assigning the signature pattern to a cluster from among a plurality of clusters based on a comparison of the signature pattern with the benchmark signature pattern, and determining an amount of life remaining for the cutting tool based on the assigned cluster.

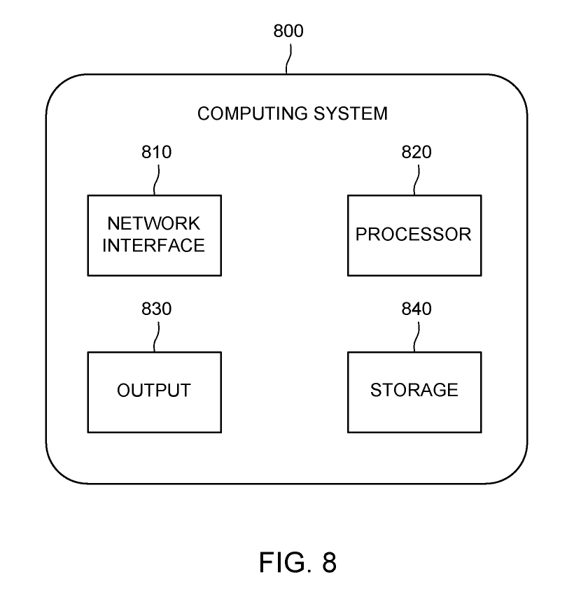

FIG. 8 illustrates a computing system 800 for determining a health of a cutting tool in accordance with an example embodiment. For example, the computing system 800 may be the cloud computing system 210 or an instance thereof, shown in FIG. 2, a database, a user device, a server, or another type of device. Also, the computing system 800 may perform the method 700 of FIG. 7. Referring to FIG. 8, the computing system 800 includes a network interface 810, a processor 820, an output 830, and a storage device 840 such as a memory. Although not shown in FIG. 8, the computing system 800 may include other components such as a display, an input unit, a receiver/transmitter, and the like.

The network interface 810 may transmit and receive data over a network such as the Internet, a private network, a public network, and the like. The network interface 810 may be a wireless interface, a wired interface, or a combination thereof. The processor 820 may include one or more processing devices each including one or more processing cores. In some examples, the processor 820 may be a multicore processor or a plurality of multicore processors. Also, the processor 820 may be fixed or it may be reconfigurable. The output 830 may output data to an embedded display of the computing system 800, an externally connected display, a display connected to the cloud, another device, and the like. The storage device 840 is not limited to a particular storage device and may include any known memory device such as RAM, ROM, hard disk, and the like, and may or may not be included within the cloud environment. The storage 840 may store software modules or other instructions which can be executed by the processor 820 to perform the method 700 shown in FIG. 7.

According to various embodiments, the processor 820 may receive operating characteristics of a cutting machine which are captured during an iteration of a cutting operation. For example, the processor 820 may receive the operating characteristics from the cutting machine via a network. In this example, the network interface 810 or a receiver may receive the operating characteristics via the network such as the Internet, a private network, a combination thereof, and the like. The processor 820 may generate a signature pattern associated with the cutting machine based on the operating characteristics. Here, the signature pattern may represent a unique pattern of the operating characteristics of the cutting machine during the cutting operation. The processor 820 may also determine health information of a cutting tool of the cutting machine based on the signature pattern and a benchmark signature pattern. For example, the health information may be a prediction of how much life the cutting tool has remaining before it needs to be replaced. The output 830 may output the determined health information of the cutting tool for display on a display device which may be embedded with the computing system 800 or a display device of another device which is connected to the computing system 800 via the network.

In some embodiments, the processor 820 may receive sensor data of a cutting force of the cutting machine, and the processor 820 may generate a signature pattern for the cutting force over time and determine the health information of the cutting tool based on the signature pattern for the cutting force and a benchmark signature pattern for the cutting force. As another example, the processor 820 may receive sensor data of acoustic emissions of the cutting machine, and the processor 820 may generate a signature pattern for the acoustic emissions over time and determine the health information of the cutting tool based on the signature pattern for the acoustic emissions and a benchmark signature pattern for the acoustic emissions. As another example, the processor 820 may receive sensor data of a vibrations of the cutting machine, and the processor 820 may generate a signature pattern for the vibrations over time and determine the health information of the cutting tool based on the signature pattern for the vibrations and a benchmark signature pattern for the vibrations. As another example, the processor 820 may receive sensor data of power consumption of the cutting machine, and generate a signature pattern for the power consumption over time and determine the health information of the cutting tool based on the signature pattern for the power consumption and a benchmark signature pattern for the power consumption.

In some examples, the processor 820 (via the network interface 810) may receive the operating characteristics from a plurality of sensors of the cutting machine. Accordingly, the processor 820 may generate a signature pattern for each sensor from among the plurality of sensors and determine the health information of the cutting tool based on a combination of the signature patterns of each of the plurality of sensors. In some embodiments, the processor 820 may generate the benchmark signature pattern based on previous iterations of cutting operation by averaging signature patterns generated by the operating characteristics of the cutting machine during the previous iterations. In some embodiments, the processor 820 may assign the signature pattern to a cluster from among a plurality of clusters based on a comparison of the signature pattern with the benchmark signature pattern, and determine an amount of life remaining for the cutting tool based on the assigned cluster.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computer-implemented method comprising:
receiving operating characteristics of a cutting machine which are captured during an iteration of a cutting operation;
generating a signature pattern associated with the cutting machine based on the operating characteristics, the signature pattern representing a unique pattern of the operating characteristics of the cutting machine during the cutting operation;
determining health information of a cutting tool of the cutting machine based on the signature pattern and a benchmark signature pattern; and
outputting the determined health information of the cutting tool for display on a display device.

2. The computer-implemented method of claim 1, wherein the determined health information of the cutting tool comprises a determined amount of life remaining before the cutting tool will fail.

3. The computer-implemented method of claim 1, wherein the received operating characteristics comprise sensor data of a cutting force of the cutting machine, the generating comprises generating a signature pattern for the cutting force over time, and the determining comprises determining the health information of the cutting tool based on the signature pattern for the cutting force and a benchmark signature pattern for the cutting force.

4. The computer-implemented method of claim 1, wherein the received operating characteristics comprise sensor data of acoustic emissions of the cutting machine, the generating comprises generating a signature pattern for the acoustic emissions over time, and the determining comprises determining the health information of the cutting tool based on the signature pattern for the acoustic emissions and a benchmark signature pattern for the acoustic emissions.

5. The computer-implemented method of claim 1, wherein the received operating characteristics comprise sensor data of vibrations of the cutting machine, the generating comprises generating a signature pattern for the vibrations over time, and the determining comprises determining the health information of the cutting tool based on the signature pattern for the vibrations and a benchmark signature pattern for the vibrations.

6. The computer-implemented method of claim 1, wherein the received operating characteristics comprise sensor data of power consumption of the cutting machine, the generating comprises generating a signature pattern for the power consumption over time, and the determining comprises determining the health information of the cutting tool based on the signature pattern for the power consumption and a benchmark signature pattern for the power consumption.

7. The computer-implemented method of claim 1, wherein the operating characteristics are received from a plurality of sensors associated with the cutting machine, the generating comprises generating a signature pattern for each sensor from among the plurality of sensors, and the determining comprises determining the health information of the cutting tool based on a combination of the signature patterns of each of the plurality of sensors.

8. The computer-implemented method of claim 1, further comprising generating the benchmark signature pattern based on previous iterations of the cutting operation by averaging signature patterns generated by the operating characteristics of the cutting machine during the previous iterations.

9. The computer-implemented method of claim 1, wherein the determining the health information comprises determining that the cutting tool should be replaced based on the signature pattern and the benchmark signature pattern and outputting a notification to the display device indicating that the cutting tool should be replaced.

10. The computer-implemented method of claim 1, wherein the determining the health information comprises assigning the signature pattern to a cluster from among a plurality of clusters based on a comparison of the signature pattern with the benchmark signature pattern, and determining an amount of life remaining for the cutting tool based on the assigned cluster.

11. A computing system comprising:
a receiver configured to receive operating characteristics of a cutting machine which are captured during an iteration of a cutting operation;
a processor configured to generate a signature pattern associated with the cutting machine based on the operating characteristics, the signature pattern representing a unique pattern of the operating characteristics of the cutting machine during the cutting operation, and determine health information of a cutting tool of the cutting machine based on the signature pattern and a benchmark signature pattern; and
an output configured to output the determined health information of the cutting tool for display on a display device.

12. The computing system of claim 11, wherein the determined health information of the cutting tool comprises a determined amount of time remaining before the cutting tool will fail.

13. The computing system of claim 11, wherein the receiver is configured to receive sensor data of a cutting force of the cutting machine, and the processor is configured to generate a signature pattern for the cutting force over time and determine the health information of the cutting tool based on the signature pattern for the cutting force and a benchmark signature pattern for the cutting force.

14. The computing system of claim 11, wherein the receiver is configured to receive sensor data of acoustic emissions of the cutting machine, and the processor is configured to generate a signature pattern for the acoustic emissions over time and determine the health information of the cutting tool based on the signature pattern for the acoustic emissions and a benchmark signature pattern for the acoustic emissions.

15. The computing system of claim 11, wherein the receiver is configured to receive sensor data of a vibrations of the cutting machine, and the processor is configured to generate a signature pattern for the vibrations over time and determine the health information of the cutting tool based on the signature pattern for the vibrations and a benchmark signature pattern for the vibrations.

16. The computing system of claim 11, wherein the receiver is configured to receive sensor data of power consumption of the cutting machine, and the processor is configured to generate a signature pattern for the power consumption over time and determine the health information of the cutting tool based on the signature pattern for the power consumption and a benchmark signature pattern for the power consumption.

17. The computing system of claim 11, wherein the receiver is configured to receive the operating characteristics from a plurality of sensors of the cutting machine, and the processor is configured to generate a signature pattern for each sensor from among the plurality of sensors and determine the health information of the cutting tool based on a combination of the signature patterns of each of the plurality of sensors.

18. The computing system of claim 11, wherein the processor is further configured to generate the benchmark signature pattern based on previous iterations of cutting operation by averaging signature patterns generated by the operating characteristics of the cutting machine during the previous iterations.

19. The computing system of claim 11, wherein the processor is configured to assign the signature pattern to a cluster from among a plurality of clusters based on a comparison of the signature pattern with the benchmark signature pattern, and determine an amount of life remaining for the cutting tool based on the assigned cluster.

20. A non-transitory computer readable medium having stored therein instructions that when executed cause a computer to perform a method comprising:
receiving operating characteristics of a cutting machine which are captured during an iteration of a cutting operation;
generating a signature pattern associated with the cutting machine based on the operating characteristics, the signature pattern representing a unique pattern of the operating characteristics of the cutting machine during the cutting operation;
determining health information of a cutting tool of the cutting machine based on the signature pattern and a benchmark signature pattern; and
outputting the determined health information of the cutting tool for display on a display device.
